(19) United States
(12) Patent Application Publication
(10) Pub. No.: US 2019/0071322 A1
(43) Pub. Date: Mar. 7, 2019

(54) FURNITURE BASE FOR A FURNITURE WALL WITH A WATER FILTER FOR A HOUSEHOLD COOLING APPLIANCE, AND SYSTEM

(71) Applicant: BSH-HAUSGERAETE GMBH, Muenchen (DE)

(72) Inventor: KARL-FRIEDRICH LAIBLE, LANGENAU (DE)

(21) Appl. No.: 15/696,674

(22) Filed: Sep. 6, 2017

(51) Int. Cl. C02F 1/00; A47L 15/42; F25D 23/02; F25D 23/06

(52) U.S. Cl. CPC C02F 1/003; A47L 15/4202; A47L 15/4253; F25D 23/028; F25D 2323/121; F25D 23/061; C02F 2201/006; C02F 2307/10; F25D 23/067

(57) ABSTRACT

A furniture base for a furniture wall. The furniture wall has at least one household cooling appliance, including a furniture part and a water filter for filtering water externally from the household cooling appliance. The water filter is arranged at the furniture part. There is also described a system.

### TECHNICAL FIELD

The invention relates to a furniture base for a furniture wall and to a system with a household cooling appliance and such a furniture base.

### BACKGROUND OF THE INVENTION

It is known that household cooling appliances can comprise a dispenser unit for dispensing liquid and/or ice form elements. Such a dispenser unit has to be connected to a water system to enable the supply of liquid such that the ice form elements to be generated can be formed from this liquid. The preparation of beverages which can be dispensed via the dispenser unit also potentially requires water, which has to be externally supplied. In this context it is known that a household cooling appliance comprises a water filter by which the externally supplied water is filtered. However, such a water filter requires adequate space.

In this context, EP 1635927 B1 teaches not to install the water filter in the housing of the device itself but in an empty space of the device which is formed beneath a bottom. To this end, the side walls of the device extend further down than the bottom such that the household cooling appliance itself comprises such a lower empty space, which is formed by the device itself. In this empty space, the water filter is arranged and arranged therein at a frontside grid, which is a component of the downwardly extending housing of the household cooling appliance.

Moreover, it is known that household appliances can also, for example, be arranged as built-in devices in a furniture wall such as a kitchen unit. In this context, an installation recess can be provided in the furniture wall which is surrounded by further components of the furniture wall. In this connection, the household appliance can also directly adjoin the furniture wall and thus as it were constitute a lateral boundary of the furniture wall.

### SUMMARY OF THE INVENTION

It is the object of the present invention to enable a compact design of a household appliance and to arrange, according to requirements, a specific functional component of the household appliance outside the household appliance.

This object is solved by a furniture base and a system according to the independent claims.

One aspect of the invention relates to a furniture base for a furniture wall. The furniture wall comprises at least one household cooling appliance. It is possible that the household cooling appliance is arranged in an installation recess of the furniture wall and surrounded on multiple sides by the components of the furniture wall. In this context, the household cooling appliance can also directly adjoin a side of the furniture wall and accordingly also be part of the furniture wall. The furniture base comprises a furniture part. The furniture base further comprises a water filter as a component of the household cooling appliance. The water filter is arranged externally to the household cooling appliance and configured to filter the water to be supplied to the household cooling appliance. The water filter is thus arranged spaced apart and distanced from the household cooling appliance. The water filter is arranged at the furniture part.

The invention further relates to a system with a household cooling appliance and a furniture base, which comprises a furniture part and a water filter which is arranged at the furniture part.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination but also in other combinations, without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the back-references of the claims.

### BRIEF DESCRIPTION OF THE DRAWINGS

Embodiments of the invention are explained in the following in more detail on the basis of schematic drawings. These show in:

FIG. 1 a schematic representation of an embodiment of a system with a furniture wall, which comprises a furniture base, and at least one household cooling appliance;

FIG. 2 a perspective view of an embodiment of a furniture base, which comprises a furniture part and a water filter;

FIG. 3 a perspective sectional view of the embodiment according to FIG. 2; and

FIG. 4 a perspective view of a water filter, as it is installed in FIG. 2 and FIG. 3.

### DETAILED DESCRIPTION OF PREFERRED EMBODIMENTS

In the figures identical or functionally identical elements are equipped with the same reference signs.

With indications “top”, “bottom”, “front”, “back”, “horizontal”, “vertical”, “depth direction”, “width direction”, “height direction” etc. the positions and orientations given in the case of intended use and intended arrangement of the furniture base are indicated.

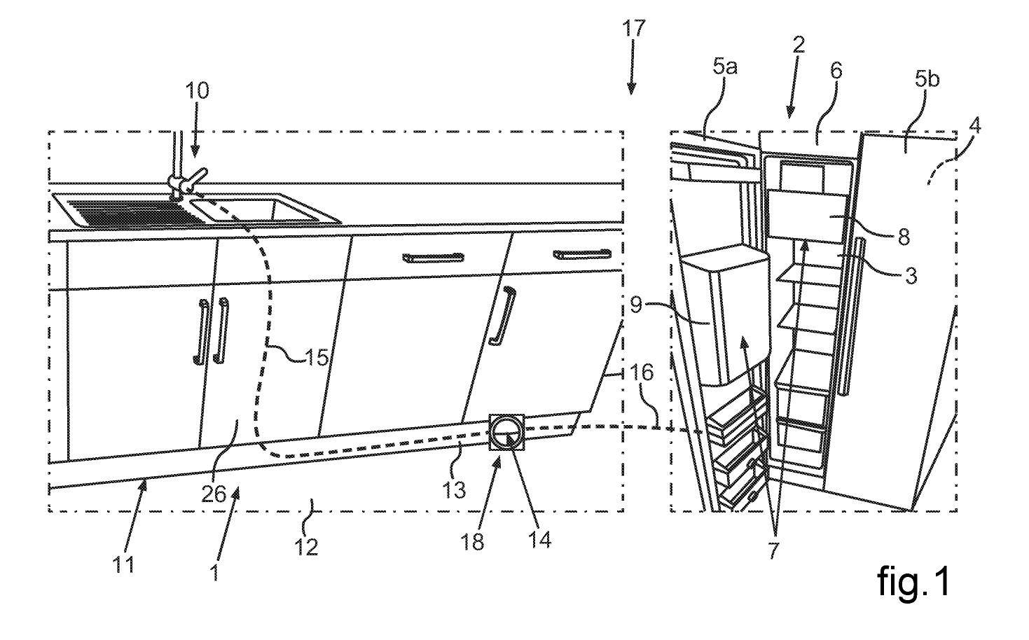

FIG. 1 shows in a schematic partial view a furniture wall 1, which is presently a kitchen unit. The furniture wall 1 further comprises a household cooling appliance 2 which, for the sake of enhanced presentation, is presently shown separately but which can also, for example, be arranged in an installation recess of the furniture wall 1 or adjoin furniture components as a lateral boundary of the furniture wall 1. The household cooling appliance 1 can be a built-in device. However, in this context, it can also be a floor-standing device.

The household cooling appliance 2 can be a refrigerator or a freezer or a fridge freezer. As shown in FIG. 1, it can comprise at least one receiving space for food, which can be a refrigerator compartment or a freezer compartment. There can also be provided a household cooling appliance 2 which comprises at least two separate receiving spaces, of which one can be a refrigerator compartment and another a freezer compartment. In the illustrated embodiment, two such receiving spaces 3 and 4 are envisaged. The first receiving space 3 can be closed by a first door 5a of the household cooling appliance 2, which is pivotably arranged at a housing 6. The further receiving space 4 can be closed by a door 5b separate therefrom, which is presently shown in the closed position.

In one embodiment, the household cooling appliance 2 comprises a dispenser unit 7 which is configured to dispense liquid and/or ice form elements. In the illustrated embodiment, the dispenser unit 7 comprises an ice maker 8 which is configured to generate and produce ice form elements from liquid. The ice maker 8 is presently arranged in the housing 6. The dispenser unit 7 moreover comprises an output unit 9 which is formed in the door 5 and via which the liquid and/or ice form elements can be dispensed. For this purpose, the door 5 comprises a recess on an outer side facing away from the receiving space 3, into which a receptacle can be inserted so that the liquid and/or ice form elements dispensed via the output unit 9 can be collected.

To enable such output of liquid and/or ice form elements it is required that the household cooling appliance 2 and in particular the dispenser unit 7 are externally supplied with water. For this purpose, the household cooling appliance 2 is connected to an external domestic water supply system 10. The furniture wall 1 comprises a furniture base 11. The furniture base 11 is arranged on a floor 12.

The furniture base 11 constitutes a lower boundary of the furniture elements and thus a lower boundary of furniture components of the furniture wall 1.

The furniture base 11 comprises a furniture part 13 which is formed as a continuous, hole-free plate. The furniture base 11 moreover comprises a water filter 14. The water filter 14 is configured to filter the water which is to be conducted from the domestic water supply system 10 to the household cooling appliance 2 via a pipe 15, presently shown schematically as a dashed line. In conventional household cooling appliances the water filter 14 is part of the household cooling appliance itself and configured to filter the water externally supplied to the household cooling appliance 2 before it reaches the dispenser unit 7. The filtered water is then conveyed to the dispenser unit 7, as illustrated by a further pipe 16 schematically drawn in as a dashed line. Thus, the filtering of the water is performed externally and remotely from the household cooling appliance 2 in the furniture base 11 itself. The water filter 14 is arranged at the furniture part 13. It is in particular non-destructively detachably arranged at the furniture part 13. By the water filter 14, filtering can be performed externally to the household cooling appliance 2.

Due to such an arrangement of the water filter 14, on the one hand a space-saving arrangement thereof spaced apart from the household cooling appliance 2 is enabled, while on the other hand the water filter 14 is easily accessible, for example for replacement or maintenance purposes. The water filter 14 is thus no longer arranged at the household cooling appliance 2, for example in an empty space, formed by side walls of the housing, underneath a bottom of the housing, but completely spaced apart from the housing 6. The arrangement of the furniture part 13 is in particular such that it is a frontside visible component which constitutes a lower border strip of the furniture wall 1. The furniture part 13 and thus likewise the furniture base 11 extend in a horizontal direction across a plurality of furniture elements of the furniture wall 1. Specifically, if the household cooling appliance 2 as a free-standing component directly laterally adjoins a side wall of the furniture wall 1, the furniture base 11 only extends as far as this side wall and in particular not below the household cooling appliance 2.

According to the illustration of FIG. 1, also a system 17 is formed which comprises the household cooling appliance 2 and the furniture base 11.

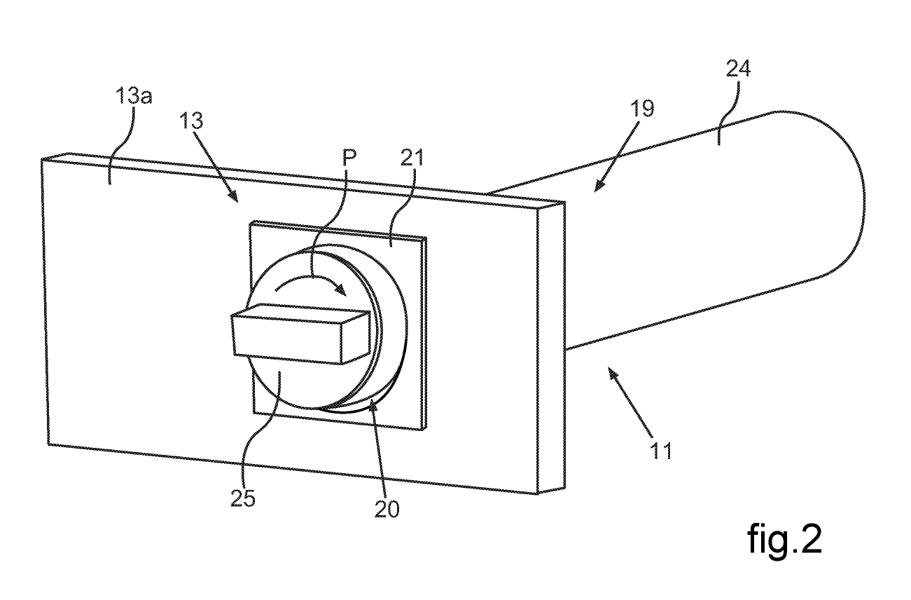

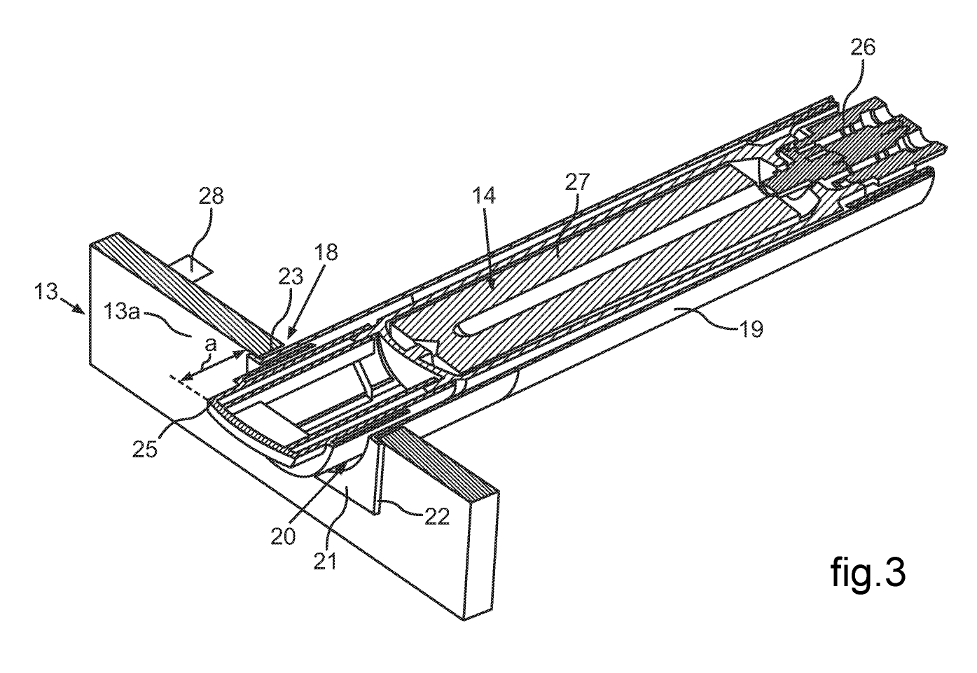

FIG. 2 shows a partial section of the furniture base 11 in a perspective view. The furniture part 13 constitutes a front plate. Besides, it can be seen that a hole 18 (FIG. 3) is formed in the furniture part 13, through which the water filter 14 extends. As can be seen from FIG. 2 and FIG. 3, the water filter 14 extends frontwards by an excess length a relative to a front side 13a of the furniture part 13 such that it protrudes in forward direction. This enhances ease of use of the water filter 14, for example when it is removed or inserted.

It is advantageously provided that the water filter 14 is arranged in a separate filter carrier 19. The filter carrier 19 can be of pipe-like or channel-like form. By such a filter carrier 19 undesirably leaking water can be collected. It is in particular provided that the filter carrier 19 is designed such that the collected water flows forwards to the furniture part 13, where it can for instance be collected in a defined manner and/or removed through an opening 20 and/or exit through the opening 20.

Preferably, the filter carrier 19 comprises a front panel 21 which constitutes a frontside flange. Thus, in a viewing direction towards the front side 13a, the hole 18 is covered at the front. Besides, by the front panel 21 mechanically stable positioning of the filter carrier 19 in the hole is enabled.

As can be seen from the perspective sectional view of FIG. 3, the front panel 21 comprises a marginal protrusion 22 or collar such that a delimiting contour 23 of the hole 18 is covered at the front. The filter carrier 19 with its channel-like section 24 and the preferably present front panel 21 is formed as a single piece and made of plastic, for example.

The filter carrier 19 is in particular formed as a collecting component for leaking water from the water filter 14.

In a further embodiment it can be provided that a valve which is connected to the water filter 14 in a fluid-conducting manner, and a pipe for conducting the filtered water to the household cooling appliance 2 are part of the furniture base 11. In such an embodiment said valve can also be arranged externally to the household cooling appliance 2. It can in particular also be arranged at the furniture part 13 in immediate proximity to the water filter 14. The valve is thus arranged externally to the household cooling appliance 2.

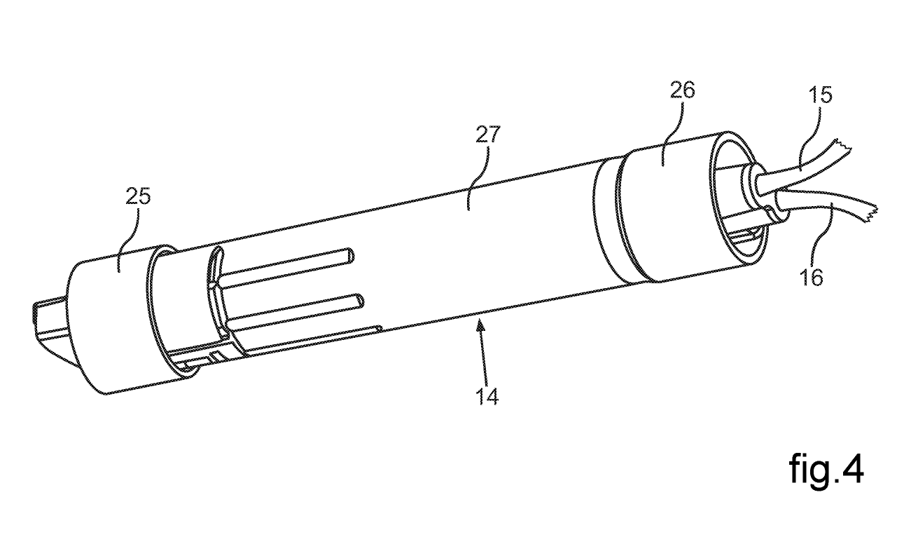

The water filter 14 comprises a handle element 25, as shown in FIG. 2 and in the perspective view of FIG. 4. The handle element 25 is also shown in FIG. 3 in a perspective sectional view. By the handle element 25 easy removal and insertion of the water filter 14 is enabled.

It is preferably provided that a filter head 26 as shown in FIG. 3 and FIG. 4 can be firmly installed in the filter carrier 19. A cartridge area 27 of the water filter 14 can be non-destructively detachably connected with the filter head 26 such that when the water filter 14 is removed only the cartridge area 27 and the handle element 25 are removed. The pipe 15 ends at the filter head 26, while the pipe 16 leads away therefrom. In FIG. 3 the above-mentioned valve 28 is shown and arranged at the furniture part 13 merely symbolically. Specifically, the removal of the water filter 14, in particular of the cartridge area 27 with the handle element 35, can be effected by rotational movement, as indicated by the arrow P in FIG. 2.

Generally, in one embodiment of the furniture base the furniture part is a front plate, wherein the front plate comprises a hole through which the water filter extends. The water filter is arranged to extend beyond a front side of the front plate by an excess length in forward direction.

In a further general idea it is envisaged that the furniture base comprises a filter carrier for the water filter, wherein the filter carrier is arranged in the hole of the furniture part. The filter carrier can be of channel-like or pipe-like form. According to a further general aspect, it is provided that the filter carrier comprises a front panel which covers the hole in the furniture part at the front. Specifically, by the front panel delimiting contours of the hole are covered at the front. In a further aspect it is envisaged that the filter carrier is formed as a single piece. It can be formed as a collecting component for leaking water from the water filter.

In a further general aspect it is provided that a valve which is connected to the water filter in a fluid-conducting manner, and a pipe for conducting the filtered water to the household cooling appliance are part of the furniture base.

In an advantageous embodiment, the furniture base with the water filter can be an upgrade module for upgrading a furniture wall.

Generally, the system can comprise a further household appliance, wherein the furniture base can be arranged beneath the further household appliance. The further household appliance can, for example, be a dishwasher. In a further aspect of the invention, this system can also be installed in the furniture wall.

List of reference signs

| | |
|---|---|
| 1 | furniture wall |
| 2 | household cooling |
| | appliance |
| 3 | receiving space |
| 4 | receiving space |
| 5a | door |
| 5b | door |
| 6 | housing |
| 7 | dispenser unit |
| 8 | ice maker |
| 9 | output unit |
| 10 | domestic water supply |
| | system |
| 11 | furniture base |
| 12 | floor |
| 13 | furniture part |
| 13a | front side |
| 14 | water filter |
| 15 | pipe |
| 16 | pipe |
| 17 | system |
| 18 | hole |
| 19 | filter carrier |
| 20 | opening |
| 21 | front panel |
| 22 | protrusion |
| 23 | delimiting contour |
| 24 | section |
| 25 | handle element |
| 26 | filter head |
| 27 | cartridge area |
| 28 | valve |
| a | excess length |
| P | arrow |

1. Furniture base for a furniture wall, wherein the furniture wall comprises at least one household cooling appliance, comprising
a furniture part and a water filter for filtering water externally from the household cooling appliance, wherein the water filter is arranged at the furniture part.

2. Furniture base according to claim 1, wherein the furniture part is a front plate, wherein the front plate comprises a hole through which the water filter extends, wherein the water filter is arranged to extend beyond a front side of the front plate by an excess length in forward direction.

3. Furniture base according to claim 2, wherein the furniture base comprises a filter carrier for the water filter, wherein filter carrier extends in the hole.

4. Furniture base according to claim 3, wherein the filter carrier is of channel-like or pipe-like form.

5. Furniture base according to claim 3, wherein the filter carrier comprises a front panel, which covers the hole at the front.

6. Furniture base according to claim 5, wherein the front panel covers delimiting contours of the hole at the front.

7. Furniture base according to claim 3, wherein the filter carrier is formed as a piece.

8. Furniture base according to claim 3, wherein the filter carrier is a collecting component for leaking water from the water filter.

9. Furniture base according to claim 1, comprising a valve, which is connected to the water filter in a fluid-conducting manner, and a pipe for conducting the filtered water to the household cooling appliance.

10. Furniture base according to claim 1, wherein the furniture base is formed as an upgrade module for upgrading a furniture wall.

11. System with a household cooling appliance and a furniture base comprising a furniture part and a water filter for filtering water externally from the household cooling appliance, wherein the water filter is arranged at the furniture part.

12. System according to claim 11, wherein:
the household cooling appliance comprises a dispenser unit for dispensing liquid and/or ice, and
the dispenser unit is connected with the furniture base in a fluid-conducting manner for conducting filtered water from the water filter to the dispenser unit.

13. System according to claim 11, wherein the system comprises a further household appliance, and the furniture base is arranged beneath the further household appliance.

14. System according to claim 13, wherein the further household appliance is a dishwasher.

15. System according to claim 11, wherein the system is installed in a furniture wall.
